(19) United States
(12) Patent Application Publication
(10) Pub. No.: US 2008/0152833 A1
(43) Pub. Date: Jun. 26, 2008

(54) Repair of Coated Substrates

(75) Inventors: Huig Klinkenberg, Katwijk (NL); Vincent Matthijs Boers, Leiden (NL); Edward Marinus, Leiden (NL)

Correspondence Address: KENYON & KENYON LLP, ONE BROADWAY, NEW YORK, NY, 10004, US

(73) Assignee: Akzo Nobel Coatings International B. V., BM Arnhem (NL)

(21) Appl. No.: 11/793,103

(22) PCT Filed: Dec. 14, 2005
(86) PCT No.: PCT/EP2005/056783

§ 371 Date: Jan. 7, 2008

Related U.S. Application Data
(60) Provisional application No. 60/644,039, filed on Jan. 18, 2005.

(30) Foreign Application Priority Data
Dec. 15, 2004 (EP) 04078405.0

(51) Int. Cl. B05D 3/06; B05D 3/00

(52) U.S. Cl. 427/520; 427/140

(57) ABSTRACT

The present invention relates to a process for repair of a coated substrate comprising the steps of a) applying a liquid, ambient temperature curable two-component coating composition on an area of the coated substrate that needs to be repaired, wherein curing of the two-component coating composition commences upon mixing of the components and does not require UV or electron beam radiation or supply of thermal energy, b) applying a film on top of the applied coating composition, c) allowing the applied coating composition to cure, and d) removing the film from the cured coating composition on the substrate. The invention also relates to a kit of parts for carrying out the process, comprising a film and a liquid, ambient temperature curable two-component coating composition.

The present invention relates to a process for repairing coated substrates and to a kit of parts for carrying out the process. Specifically, the invention relates to the repair of coated substrates that show minor damage in one or more places. For example, there may be a spot, or a small dent, or a scratch in the coated surface, or locally the substrate may be bare instead of coated. In the present context, the term coated substrate represents a substrate that is obtainable by applying one or more layers of a coating composition comprising an organic or primarily organic binder material, for instance lacquer or paint, on a substrate.

International patent application WO 03/074198 describes a process for coating a substrate where in a first step a radiation curable coating is applied to a substrate and/or a radiation permeable film, next the substrate and the film are pressed together in such a way that the coating is sandwiched between them, thereafter the coating is cured by irradiation through the film, and in a subsequent step the film is removed from the coated substrate. A durable cured coating with improved mechanical properties is obtained.

International patent application WO 03/092912 relates to a process for repairing coated substrate surfaces by means of thermally curable coating compositions. The process in particular is suitable for repairing small blemished areas, for example in the context of vehicle repair coating in a paint shop. The process comprises the steps of providing a backing film coated on one side with an uncured or at least partially cured coating layer of a thermally curable coating composition, applying the film with its coated side onto the blemished area to be repaired, supplying thermal energy to the coating applied, and removing the backing film. When selecting the binders for the coating compositions to be used in the process care must be taken to use only those thermally crosslinkable binders that are stable in storage prior to the supply of thermal energy.

In order to achieve invisible repairs, in professional vehicle body repair shops one usually sands and re-coats the whole panel or part, or even the entire vehicle. In professional body repair shops the coating is generally applied by spraying. For spray application of a repair coating those parts of the vehicle which need no repair, such as adjacent body panels, windows, mirrors, or rubber parts, have to taped off with a temporary protective layer in order to prevent the deposition of droplets of spray mist on these parts. Spray application has to be carried out in a spray booth and requires personal protection measures. A disadvantage of this approach is that sanding, taping-off, and re-coating are very time consuming. Further, the method requires, proportionally, an enormous amount of coating material to repair minor damage to the coating.

Small scratches on exterior or interior vehicle body parts are frequently also repaired by untrained persons, for example automobile owners. This approach is generally referred to as the “do-it-yourself” approach. A disadvantage of the do-it-yourself approach is that the water borne or solvent borne coating compositions generally used therefor result in a coating having inferior properties compared to the original, industrially applied, coating.

A drawback of the processes known from WO 03/074198 and WO 03/092912 is that they require ultraviolet (UV) or electron beam radiation or the supply of thermal energy to cure the coating. Suitable sources of UV or electron beam radiation are often rather expensive and they may be difficult to transport so as to guide the radiation to a particular spot to be irradiated. In the actual industrial practice of radiation curing often use is made of a stationary irradiation zone through which the items to be irradiated are guided. Furthermore, protective measures have to be taken to prevent exposure of humans to the harmful UV or electron beam radiation in order to prevent injury. Likewise, equipment for the supply of thermal energy, such as infrared radiation sources, is not always available in small enterprises and even less so in a do-it-yourself environment.

In view of the above, the known processes are not very suitable for small enterprises and even less so for a do-it-yourself application.

The current invention seeks to provide a process which is not hampered by the above-mentioned drawbacks. More in particular, there is a need for a process for repair of a coated substrate which leads to a durable cured coating with good mechanical, chemical, and optical properties and has the same good coating properties as the original coating layer in the surrounding areas, which process should be suitable for small enterprises and particularly for do-it-yourself application, as well as for a professional environment. The process should lead to an almost invisible repair of coated substrates and use less coating material and result in less pollution than the processes normally applied in professional body shops.

In order to meet this need the present invention provides a process for repair of a coated substrate comprising the steps of
a) applying a liquid, ambient temperature curable two-component coating composition on an area of the coated substrate that needs to be repaired, wherein curing of the two-component coating composition commences upon mixing of the components and does not require UV or electron beam radiation or supply of thermal energy,
b) applying a film on top of the applied coating composition,
c) allowing the applied coating composition to cure, and
d) removing the film from the cured coating composition on the substrate.

### BRIEF DESCRIPTION OF THE DRAWINGS

FIG. 1 is a schematic view of a coated substrate 2 damaged by a scratch 1.

FIG. 2 is a schematic view of the application of a liquid coating composition 4 on the damaged area 1 of a coated substrate 2 using a syringe 3.

FIG. 3 is a schematic view of the application of a film 5 on top of the applied coating composition 4.

FIG. 4 is a schematic view of the applied film 5 on top of the applied coating composition 4 spread out over a small area around the damaged area 1. The process according to the invention is very suitable for application in small enterprises, and in particular for do-it-yourself application, although it can equally well be applied in a professional environment. Due to the use of a liquid, ambient temperature curable two-component coating composition, UV or electron beam radiation or supply of thermal energy is not required for curing the coating composition.

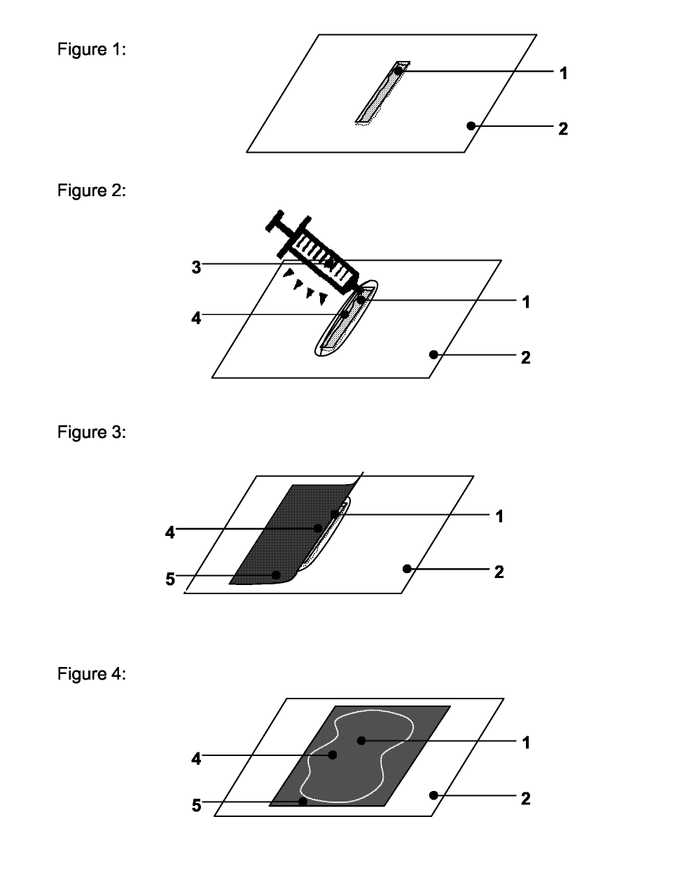

In addition, the process requires less coating material and results in less pollution than the processes normally applied in professional body shops to repair coated substrates of vehicle bodies or parts thereof. Further, minor damage to the coating layer, such as a dent, a scratch, or a bare area, can be repaired in less processing time, with lower energy costs, and without damaging the area around the damaged area. It is possible to obtain even and glossy surfaces without the need to apply the coating composition by spraying. Accordingly, it is not required to tape off the parts of the coating adjacent to the damaged area, since there is no need for protection against the deposition of spray mist.

A particular advantage of the process is that during curing the repair coating is protected by the film from dust, moisture, and mechanical damage which might otherwise affect the quality and appearance of the repair coating. Therefore, it is possible to use an ambient temperature curable two-component coating composition having a relatively slow drying speed and consequently a long pot life, because the film can be removed after curing is complete, e.g. after one or several days of curing. Hence, there is no need to use fast curing two-component coating compositions having a short pot life, which are difficult to handle in a do-it-yourself environment.

The process according to the present invention can be used not only to perform an esthetical repair, but also to really restore the coating layer. A further advantage lies in the fact that the surface configuration on the side of the film facing the coating layer can be imparted to the repair coating. This enables an almost invisible repair of coated substrates with, in principle, any decorative effect. For example, it is possible to repair a high gloss coated substrate by using a high gloss film. Low gloss substrates can be repaired using low gloss films, which has the advantage that it is not necessary to add a matting agent to the coating composition. It is also possible to repair textured coated substrates, for example substrates with a leather-like structure surface. It is also possible that after step d) of the process of the invention a final polishing step is carried out. Such a polishing step can minimize any residual visible differences between the repaired area and the surrounding coating.

Furthermore, with the process it is possible to obtain a repaired area which has the same good coating properties as the original coating layer in the surrounding areas. For instance, the substrate can be protected in practically the same way, and a similar chemical resistance and abrasion resistance can be obtained as with the original, probably industrially applied, coating layer.

In one embodiment of the process, in step a) a very small excess of coating composition is applied on the damaged area that needs to be repaired. Next, by means of pressure on the film, this surplus of coating material on the damaged area is spread out over a small area around the damaged area. This results in a smooth transition between the original surface of the (top) coat and the repaired area.

The process according to the invention is suitable for repairing any coated substrate, in particular coated metal and plastic substrates. The metal may be any metal or alloy to which a coating can be applied. As particular examples iron, aluminium, and magnesium may be mentioned. It is to be understood that iron includes steel, stainless steel, as well as zinc plated and otherwise pre-treated steel. Further, metals and alloys used as coated components of vehicles may be specifically mentioned.

The plastic may be any primarily organic polymeric material to which a coating can be applied. As particular examples polyolefins, such as polyethylene, polypropylene, polybutadiene, polystyrene, polyvinylchloride, polyurethanes, polyamides, polyesters, as well as mixtures and blends thereof, may be mentioned. Also copolymers are included, for example polyacrylates, acrylonitrile-butadiene-styrene terpolymers, and styrene-butadiene copolymers. The organic polymeric material may also contain organic or inorganic fillers and/or reinforcement means, such as fibres. Also laminates are included. Further, organic polymeric materials used as coated components of vehicles may be specifically mentioned. If required, any dirt or loose debris may be removed from the damaged area of the coated substrate by well known standard cleaning operations prior to carrying out the process according to the invention.

The process is very suitable for repairing minor damage, e.g. scratches and dents, in the coating layers of cars or transportation vehicles or parts thereof. The process is also very suitable for repairing the multi-layer coatings which are frequently encountered on vehicles. These multi-layer coatings often comprise a clear top coat on a colour- or effect-imparting base coat. The process according to the invention is equally suitable for repairing a substrate having a colour-imparting pigmented top coat.

If the substrate requiring repair is coated with a multi-layer coating, it is also possible to repair these layers consecutively with the process of the invention. If, for instance, a base coat clear coat system is to be repaired, one could first apply a colour- and/or effect-imparting base coat composition using the process of the invention, followed by the application of a clear coat again using the process of the invention. Alternatively, it is also possible to repair a base coat clear coat system by first applying a colour- and/or effect-imparting conventional base coat layer to the damaged area by a standard method, such as brushing, followed by the application of a clear coat layer according to the process of the present invention.

The invention also relates to a kit of parts for carrying out the process according to the invention, comprising
a) a film and
b) a liquid, ambient temperature curable two-component coating composition, wherein curing of the two-component coating composition commences upon mixing of the components and does not require UV or electron beam radiation or supply of thermal energy.

The kit of parts may also comprise other components which may be useful in the course of repairing a coated substrate. Examples thereof are cleaning equipment, such as a cleaning cloth, which may optionally be impregnated with a cleaning liquid, or polishing equipment, such as a polishing paste or liquid and cotton wool or a polishing cloth.

### The Ambient Temperature Curable Two-Component Coating Composition

The ambient temperature curable two-component coating compositions frequently used in professional vehicle refinishing operations and which are generally known to the skilled person are suitable for use in the process according to the present invention. By two-component coating composition is meant a coating composition which is prepared prior to use by combining and mixing at least two components, such as a binder and a hardener component, which are stored and transported in separate containers, and wherein curing of the two-component coating composition commences upon mixing of the components and does not require UV or electron beam radiation or supply of thermal energy. The term two-component coating composition is to be understood to include compositions to which a third or fourth component is added prior to use, such as a diluent and/or an activator.

In one embodiment of the process according to the invention the components of the coating composition are mixed prior to step a), i.e. prior to applying the composition to a substrate. In an alternative embodiment of the process, at least one component of the coating composition is applied to the substrate in step a), and at least one other component of the coating composition is applied to one surface of the film in a process step a1). Subsequently, the coated surface of the film is applied on top of the applied coating composition of step a) such that the components applied in steps a) and a1) come into contact and are at least partially mixed. Since in this embodiment there is no need to mix the components prior to application, any inconvenience associated with the limited pot life of a mixed two-component composition is avoided.

The two-component coating composition cures by a chemical crosslinking reaction which commences at ambient temperature upon mixing of the at least two components. For the purpose of the process according to the invention water borne and solvent borne two-component coating compositions can be employed.

Unlike in a process of spray application, in the process according to the invention there is no need to atomize the coating composition in fine particles. The generation of an even, glossy surface does not rely solely on the levelling of the applied coating composition, but is assisted and/or caused by the application of the film in step b) of the process. Therefore, the viscosity of coating compositions used in the process according to the inventions is not particularly limited. The viscosity at application temperature of the coating compositions may for example be in the range of 5 mPa*s to 15,000 mPa*s, or mPa*s to 10,000 mPa*s. Coating compositions having a higher viscosity than those applied via conventional techniques, i.e. spraying and or brushing, are suitable for use in the process according to the invention. Such higher viscous coating compositions require less diluent in the form of volatile organic solvents or water. A further advantage of higher viscous coating compositions is that the tendency towards sagging upon application on vertical surfaces is reduced. Accordingly, coating compositions having a low volatile organic content, i.e. less than 450 grams per litre, or less than 420 grams per litre, are very suitable. The coating composition may comprise less than 40% by weight volatile organic compounds, or less than 30% by weight, or even less than 5% by weight of volatile organic compounds. The composition can also contain water, for example up to 40% by weight of water or less than 5% by weight water, calculated on the total weight of the coating composition.

If the coating composition comprises a volatile organic compound and/or water, at least the major part of these is generally allowed to evaporate after the application of the composition, before application of the film on top of the applied coating composition. Consequently, in the process according to the present invention the coating composition applied may also be a so-called 100% solids curable coating composition, i.e. a composition comprising less than 3% by weight volatile organic compounds and less than 2% by weight water. A 100% solids system hardly requires an evaporation phase between application and placement of the film.

The possibility to use coating compositions having a higher viscosity than conventional spray applied compositions also has a favourable effect on the sagging tendency of the applied coating, i.e. a coating layer with higher layer thickness can be applied to vertical surfaces without sagging. The film applied in step b) of the process further assists to prevent sagging. As a consequence, deeper pits, dents or scratches in the coated substrate to be repaired can be filled and covered in a single process, without the need to apply a separate filler or putty material.

Depending on the coated substrate to be repaired, the coating composition can be a clear coat composition or a coating composition comprising one or more pigments. If the coating composition comprises pigments, the pigments are suitably selected so as to match the colour of the substrate to be repaired. The coating composition used in the process according to the invention can also contain one or more fillers or additives. The fillers can be any fillers known to those skilled in the art, e.g., barium sulphate, calcium sulphate, calcium carbonate, silicas or silicates (such as talc, feldspar, and china clay). Additives such as aluminium oxide, silicon carbide, for instance carborundum, ceramic particles, glass particles, stabilizers, antioxidants, levelling agents, anti-settling agents, anti-static agents, matting agents, rheology modifiers, surface-active agents, amine synergists, waxes, or adhesion promoters can also be added. In general, the coating composition used in the process according to the present invention comprises 0 to 50% by weight of fillers and/or additives, calculated on the total weight of the coating composition.

The ambient temperature curable two-component coating compositions can comprise polyisocyanate crosslinkers in at least one of the components. Suitable compounds with an effective number of isocyanate groups include any isocyanate known from polyurethane chemistry. Examples of suitable isocyanates are the isocyanurate trimer of 1,6-diisocyanatohexane, the isocyanurate trimer of isophorone diisocyanate, the uretdion dimer of 1,6-diisocyanatohexane, the biuret of 1,6-diisocyanatohexane, the allophanate of 1,6-diisocyanatohexane, and mixtures thereof. The isocyanate groups can also be covalently attached to a resin. When one component of the two-component coating composition comprises polyisocyanate crosslinkers, at least one other component comprises a resin or compound comprising isocyanate-reactive groups. Such isocyanate-reactive groups comprise for example hydroxyl groups, amine groups, carboxylic acid groups, and thiol groups. Examples of suitable resins and compounds having thiol groups are described in International patent application WO 01/92362. Suitable resins comprising isocyanate-reactive groups include hydroxyl-functional polyaddition polymers, e.g. poly(meth)acrylate resins, hydroxyl-functional polyesters, and hydroxyl-functional polyurethanes, for example such as described in U.S. Pat. No. 5,155,201 and U.S. Pat. No. 6,096,835. Other suitable compounds having isocyanate-reactive groups are latent hydroxyl compounds, for example bicyclic orthoester-functional compounds, such as described in WO 97/31073.

In a further embodiment the ambient temperature curable two-component coating composition can comprise epoxide groups in at least one of the components. Suitable compounds with an effective number of epoxide groups include any epoxide known from coatings chemistry, such as glycidyl ethers, glycidyl esters, and epoxidized unsaturated carbon-carbon bond-containing compounds. Examples include diglycidyl or polyglycidyl ethers of (cyclo)-aliphatic or aromatic hydroxyl compounds, such as ethylene glycol, glycerol, cyclohexane diol, and mononuclear or polynuclear difunctional or trifunctional phenols and bisphenols such as bisphenol A and bisphenol F; epoxidized oils and epoxidized aliphatic and/or cycloaliphatic alkenes, such as dipentene dioxide, dicyclopentadiene dioxide, and vinyl cyclohexene dioxide. The epoxide groups can also be covalently attached to at least one resin.

When one component of the two-component coating composition comprises epoxide groups, at least one other component comprises a resin or compound comprising epoxide-reactive groups. Such epoxide-reactive groups comprise for example thiol groups, phosphonic acid groups, carboxylic acid groups, hydroxyl groups or amine groups. Suitable resins comprising epoxide-reactive groups include amine-functional resins, thiol-functional resins, carboxylic acid-functional resins, hydroxyl-functional resins, and phosphonic acid-functional resins.

Said amine groups may also be of the polyoxyalkyleneamine type, commercially available as Jeffamines. Further examples are a polyamine obtainable by reaction of a polyepoxide with an amino compound having at least two active hydrogen atoms at a ratio of at most 0.5 equivalent of active hydrogen atoms per epoxide equivalent, followed by conversion of the residual epoxide groups with ammonia, and a blocked amine resin such as a polyketimine or polyaldimine.

In a further embodiment the ambient temperature curable two-component coating composition can comprise Michael acceptor groups in at least one of the components. Suitable compounds with an effective number of Michael acceptor groups include any compound containing two or more olefinically unsaturated groups, with the olefinically unsaturated groups comprising at least one electron-withdrawing functionality linked to a carbon atom of the unsaturated bond, as described in WO 00/64959 incorporated herein by reference. The Michael acceptor groups can also be covalently attached to at least one resin. Suitable resins of this type include (meth)acryloyl-functional polyaddition polymers, polyurethanes, and polyesters. Examples of such resins are described in U.S. Pat. No. 4,990,577 and references cited therein.

When one component of the two-component coating composition comprises Michael acceptor groups, at least one other component comprises a resin or compound comprising Michael donor groups. Such Michael donor groups comprise for example 2,4-pentadione groups, acetoacetate groups, malonate groups, thiol groups, and amine groups. Suitable resins comprising Michael donor groups are described in more detail in EP 0161697 A and U.S. Pat. No. 4,772,680.

In a further embodiment the ambient temperature curable two-component coating composition can comprise electron rich carbon-carbon double bond-containing groups in at least one of the components. Suitable compounds with an effective number of electron rich carbon-carbon double bond-containing groups include any compound containing carbon-carbon double bonds substituted with ether, ester, and alkyl groups. Examples of groups having these types of carbon-carbon double bonds are: allyl, allyl ether, vinyl ether, vinyl ester, and unsaturated fatty acid groups. The electron rich carbon-carbon double bond-containing groups can also be covalently attached to at least one resin. Suitable resins of this type include polyesters having allyl ether groups, unsaturated fatty acid-functional groups or vinyl ether groups. Examples of such resins are described in WO 99/47617.

When one component of the two-component coating composition comprises electron rich carbon-carbon double bond-containing groups, at least one other component comprises a resin or compound comprising electron rich carbon-carbon double bond-reactive groups. Such electron rich carbon-carbon double bond-reactive groups comprise for example electron poor carbon-carbon double bonds, which can undergo curing by a charge-transfer polymerization mechanism, such as described in U.S. Pat. No. 5,446,073 and U.S. Pat. No. 6,271,339. If the electron rich carbon-carbon double bonds are suitable dienes, they can also be cured by a Diels-Alder addition reaction, such as described in EP 0357110A.

In a particular embodiment of the invention the electron rich carbon-carbon double bond-containing groups as defined above can also be cured by a cationic polymerization reaction.

In a still further embodiment the ambient temperature curable two-component coating composition can comprise acetal groups in at least one of the components. Suitable compounds with an effective number of acetal groups include those based on aminoacetals represented by the formula below

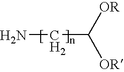

wherein n is an integer from 1 to 10 and R′ and R′ may be the same or different and represent alkyl groups with 1 to 4 carbon atoms. Such compounds and resins are known in the art. In United States patent U.S. Pat. No. 4,663,410 the preparation and use of polymerizable amide acetals from aminoacetals is described. Also the direct reaction of an aminoacetal with either a polymerizable monoisocyanate such as m-isopropenyl-dimethylbenzyl isocyanate or with a polyisocyanate, such as described in European patent application EP 1050550 A, is a suitable route towards acetal-functional compounds and resins. Acetal-functional compounds and resins obtainable by amidation of esters with aminoacetals of formula II can also be used. The preparation of suitable acetal-functional binders of this kind is for example described in United States patent U.S. Pat. No. 5,360,876.

When one component of the two-component coating composition comprises acetal groups, at least one other component comprises a resin or compound comprising acetal-reactive groups. Such acetal-reactive groups comprise for example thiol groups, hydroxyl groups, carbamate groups, and acetal groups. In a still further embodiment the ambient temperature curable two-component coating composition can comprise cyclocarbonate groups in at least one of the components. Compounds and resins with an effective number of cyclo-carbonate groups can conveniently be prepared from epoxide-functional precursors, as mentioned above. The reaction of epoxides with carbon dioxide leads to cyclic carbonates and is well known in the art.

When one component of the two-component coating composition comprises cyclocarbonate groups, at least one other component comprises a resin or compound comprising cyclocarbonate-reactive groups. Suitable cyclo-carbonate-reactive groups include the same groups already described as epoxide-reactive groups.

In a still further embodiment the ambient temperature curable two-component coating composition can comprise carbodiimide groups in at least one of the components. Suitable compounds and resins comprising carbodiimide groups are commercially available, for example XL-29SE from Dow Chemical Company. When one component of the two-component coating composition comprises carbodiimide groups, at least one other component comprises a resin or compound comprising carbodiimide-reactive groups. Examples of such carbodiimide-reactive groups are carboxylic acid and carboxylate groups.

The two-component coating composition can also comprise aldehyde groups and aldehyde-reactive groups, such as described in WO 02/14399.

In still another embodiment, the two-component coating composition comprises acetoacetate groups and, optionally blocked, primary or secondary amine groups, such as described in U.S. Pat. No. 4,772,680.

If the ambient temperature curable two-component coating composition requires moisture for curing, measures have to be taken to ensure that sufficient moisture for curing is available. This can for example be accomplished by addition of the required amount of water to one of the components of the coating composition. Alternatively, the application of the film in step b) of the process can be postponed until a sufficient amount of atmospheric moisture has entered the applied coating composition. It is also possible to apply a water or water vapour permeable film in step b). Examples of moisture curable two-component coating compositions are compositions comprising alkoxy silane groups and compositions comprising aldimine or ketimine crosslinkers. Compounds and resins with an effective number of alkoxy silane groups, as well as alkoxy silane-reactive groups, are well known in the art. Examples are described in WO 98/23691. Further examples of moisture curable two-component coating compositions are compositions comprising latent hydroxyl compounds and a hydroxyl-reactive crosslinker, such as described in International patent application WO 97/31073.

As mentioned above, the two-component coating composition cures by a chemical crosslinking reaction which commences at ambient temperature upon mixing of the at least two components.

It is also within the scope of the invention that curing of the coating composition in step c) is optionally accelerated by heating. The extent of heating must of course be limited to temperatures which do not affect the substrate or the film. This is of particular importance in the case of plastic substrates or films consisting of a polymer having a low melting temperature. A skilled person will be well aware of the maximum temperature which can be applied in individual cases. Heating can for example be carried out by irradiation with infrared radiation or near infrared radiation. Alternatively, in particular when the process of the invention is carried out in a do-it-yourself environment, heating may be carried out with a hot air blower, such as a domestic hair dryer.

It is also possible that curing of the coating composition in step c) is accelerated by irradiation with actinic radiation through the film. In this case, a film is selected which is actinic radiation permeable. Within the framework of the present invention, actinic radiation is electromagnetic radiation capable of initiating or accelerating a chemical reaction. Examples of actinic radiation are UV radiation, electron beam radiation, and sunlight.

An ambient temperature curable two-component coating composition comprising a base and a base-catalyzed polymerizable or curable material can be employed in the process according to the invention. If the base is present as a photolatent base, curing can be accelerated by irradiation with actinic radiation, as described above. Examples of suitable photolatent bases are described in European patent application EP 0882072 A, in International Patent Application WO 94/28075, and in International Patent Application WO 01/92362.

The photolatent base may be selected from a 4-(ortho-nitrophenyl) dihydropyridine, optionally substituted with alkyl ether and/or alkyl ester groups, a quaternary organo-boron photoinitiator, and an α-amino acetophenone. An example of an α-amino acetophenone is a compound according to the following formula (I):

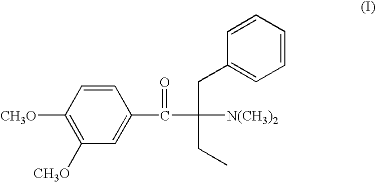

The advantage of this α-amino acetophenone is that it is a sufficiently strong base to cause slow curing of a base catalyzed two-component composition. Upon irradiation of a base catalyzed two-component composition comprising this α-amino acetophenone with actinic radiation a considerably stronger base is released, and curing is accelerated. A further advantage is that activation of this α-amino acetophenone can be effected by irradiation with sunlight. Thus, if a base catalyzed two-component composition comprising this α-amino acetophenone is used in the process according to the invention, curing of the applied coating composition can be accelerated by exposure to sunlight. If, for instance, a scratch or a small dent on a car is repaired, curing of the applied coating composition is accelerated while the car is in use and the repaired spot is exposed to sunlight.

Mixtures comprising Michael donors, such as polyfunctional acetoacetates or malonates, and polyfunctional Michael acceptors, such as acryloyl-functional compounds, are suitable as base-catalyzed curable material. Such mixtures are described in more detail in the above-mentioned EP 0882072 A and WO 94/28075.

In a particular embodiment the liquid, ambient temperature curable two-component coating composition comprises at least one polyisocyanate, at least one compound comprising at least one thiol group, and an α-amino acetophenone photolatent base. Such coating compositions are described in WO 01/92362.

### Other Components of the Coating Composition

In one embodiment the curable coating composition used in the process according to the invention is a clear coating composition, i.e. a coating composition which is essentially free of colour- and/or effect-imparting pigments. Such a clear coating composition is generally used to repair a clear coat, for example a clear coat which is the top layer in a multi-layer coating.

For the repair of substrates having a colour or effect imparting coating the curable coating composition used in the process according to the present invention can also contain one or more pigments. In principle, all pigments known to those skilled in the art can be used. In this case pigmentation is generally adapted to match the colour and/or effect of the damaged original coating.

Also other polymers can be incorporated into the coating composition. These polymers may be used to modify the viscosity, tack, adhesion, or film forming properties of the coating formulation and/or to modify the general film properties of the cured coating, such as stain resistance, flexibility or adhesion. Examples are cellulose acetate butyrate (various grades, ex Eastman), Laropal materials, (ex BASF), Paraloid materials, (ex Rohm and Haas), and Ucar materials (ex Union Carbide). In general, the coating composition used in the process according to the present invention comprises 0 to 20% by weight of such polymers.

### The Film Applied on Top of the Applied Coating Composition

Generally, a film is chosen that shows good release properties from the coating. When there is good film release, the film can be removed from the coated substrate with the repair coating remaining virtually undamaged. The coating compositions used in a process according to the present invention are suitable for being combined with a wide range of film types, including untreated films. In order to ensure good release properties of the film, the film may be treated. The type of film treatment used should be adjusted to the type of film and the type of coating used in the repair process according to the present invention. The film can for instance be coated with a release coating. Such a release coating may contain silicone or a fluoropolymer such as polytetrafluoroethylene as release agent. U.S. Pat. No. 5,037,668, for instance, describes a silicone-free fluoropolymer comprising an acrylate-type release coating.

The film can comprise, e.g., aluminium foil or an aluminized layer, for instance an aluminized polyester film, plastic or paper. The film can be rigid or flexible, and may be of any desired thickness. Generally, the film used in the process is sufficiently flexible to follow the substrate's contours. However, for spot repairs the spot frequently is small enough to be treated as if it were a plane.

It will be readily understood that upon contact with the applied coating composition the film should not be dissolved or swollen by the coating composition or components thereof. Otherwise, the coating composition's polymer matrix and the swollen film may blend over a small distance, leading to surface defects of the applied coating upon removal of the film. Swelling of the film is also undesirable because it can compromise the dimensional stability of the film.

If curing of the coating is to be accelerated or supported by UV radiation and/or visible light, such as sunlight, the film has to be sufficiently transparent to the radiation. Curing by regular UV radiation is useful in industry, but not very practical in a do-it-yourself environment, as mentioned above. In that case, the film has to be transparent to low-energy UV radiation. Consequently, in the case of curing by (low-energy) UV radiation, the film can comprise quartz glass or glass plate or a polymeric material, for example polyvinyl chloride, acetate, polyethylene, polyester, an acrylic polymer, polyethylene naphthalate, polyethylene terephthalate or polycarbonate.

In one embodiment of the process the film applied on top of the applied coating composition is water-soluble. Water-soluble films can be made from water-soluble organic polymers. Such polymers are well known in the art and as suitable examples may be mentioned polyvinyl alcohol, natural or modified starch, polyalkylene oxide, e.g. polyethyleneoxide or polymers modified therewith, polymers and copolymers of (meth)acrylic amide, meth(acrylic) acid or other salt forming monomers. When a water-soluble film is used, removal of the film from the cured coating composition can be carried out by washing away the film with water or with an aqueous solution. If the substrate to be repaired is a vehicle, the film can for instance be left on the repaired substrate until the next routine cleaning operation where the water-soluble film is washed away, for example in a car wash installation.

### Equipment and Methods of Application

Equipment known to those skilled in the art can be used to apply the coating composition to the damaged area, e.g., a brush, a syringe, a rod, or a spout. In order to facilitate mixing of the two-component coating composition prior to application in the required mixing ratio, the at least two components can be provided in containers having separate chambers comprising the components in the required amounts. Suitable two-component cartridges and dispensers are commercially available in the form of two-component syringes in conjunction with a disposable static mixer, for example from TAH industries. Such two-component cartridges eliminate the need for the end user of measuring out materials from separate syringes, tubes, or jars. Cross-contamination of the components is avoided, the amount of waste material is minimized, and the shelf life of the unused material is improved. The static mixer can be disposed of after application, while the remainder of the two components remains unreacted in the separate cartridges, ready for use with a new static mixer. Accordingly, in one embodiment the two-component coating composition is provided in a two-component cartridge, in particular in the form of a kit of parts together with a film suitable for carrying out the process of the invention.

Equipment known to those skilled in the art can be used to smoothen the coating underneath the film, e.g., a knife, a thumb, a rod, or a roller coater. Actinic radiation sources which may be used to accelerate curing are those customary for electron beam and UV. For example, UV sources such as high-, medium-, and low-pressure mercury lamps can be used. Further examples are fluorescent tubes, deuterium halogen light sources, laser light sources, mercury-xenon lamps, UV-light emitting diodes (LED), and metal halide lamps. Also, for instance, gallium and other doped lamps can be used, especially for pigmented coatings. It is also possible to accelerate curing of the coating composition by means of short pulses of actinic radiation.

In one embodiment of the present invention, especially when accelerating the curing of clear coats, the applied coating composition is irradiated using low-energy UV sources, i.e. by so-called daylight cure. Low-energy UV sources emit radiation of longer wavelengths than conventional UV sources. Low-energy UV sources emit hardly any UV-C radiation; they predominantly emit UV-A, and radiation with a wavelength at the border of UV-B and UV-A. One advantage of using a radiation source emitting radiation having a wavelength of 200 nm≦λ≦500 nm is that it is safer to use than conventional UV sources, which emit a relatively high amount of UV-C and/or UV-B radiation. This is especially of importance in a do-it-yourself environment. Another advantage is that daylight cure lamps are cheaper than conventional UV lamps. Commercially available daylight cure lamps are, for instance, solarium-type lamps and specific fluorescent lamps such as TL03, TL05 or TL09 lamps (ex Philips) and BLB UV lamps (ex CLE Design). As an example of a commercially available daylight cure lamp that emits short light pulses may be mentioned the mercury-free UV/VIS flash lamps of Xenon. Alternatively, acceleration of the curing can also be achieved by irradiation with natural sunlight instead of using an artificial source of radiation.

The invention will be elucidated with reference to the following examples.

### EXAMPLES

Materials used:
Autosurfacer 940 HS: Primer from Akzo Nobel Car Refinishes
Autobase Plus: Solvent borne base coat from Akzo Nobel Car Refinishes
Autoclear LV Ultra: Two-component solvent borne clear coat based on a polyester resin and a polyisocyanate crosslinker from Akzo Nobel Car Refinishes
Melinex 377: Polyester Film from DuPont Teijin Films
Tolonate HDT LV: A polyisocyanate from Rhodia
Byk 306: A surface active agent from Byk-Chemie

Standard damaged coated substrates were prepared by applying a multi-layer coating to pre-treated steel panels. Consecutive layers of Autosurfacer 940 HS, Autobase Plus, and Autoclear LV Ultra were spray-applied and cured as prescribed in the technical documentation of these products. Subsequently, the clear coat layer was damaged by scratching with a knife.

### Example 1

A liquid two-component clear coat composition was prepared by mixing the binder and the hardener components of Autoclear LV Ultra in the volume ratio of 3:1 as prescribed in the technical documentation of that product. However, the additional thinner component prescribed to prepare a sprayable clear coat composition was not added to the clear coat composition. A syringe was filled with the liquid clear coat composition, and the composition was applied to the damaged area, i.e. the scratch, of a standard damaged coated substrate as described above. A small excess of coating composition was applied. Subsequently, a piece of Melinex 377 polyester film was applied on top of the applied coating composition. A slight pressure was applied to the film with a thumb in order to spread out the surplus coating material over a small area around the damaged area, resulting in a smooth transition between the original surface and the repaired area. After allowing the applied coating composition to cure for about 4 hours at room temperature, the film was removed from the cured coating composition, resulting in a smoothly repaired coated substrate.

### Example 2

The same procedure as in Example 1 was followed. However, after application of the film and spreading of the surplus coating material, the panel was heated to 60° C. for 30 minutes and subsequently allowed to cool to room temperature. Immediately after cooling the film was removed from the cured coating composition, resulting in a smoothly repaired coated substrate.

### Example 3

The binder and the hardener component Autoclear LV Ultra were put into a two-component cartridge syringe having a 3:1 volume ratio for the two components. Attached to the syringe was a static mixer. The two components were simultaneously mixed and applied to the damaged area, i.e. the scratch, of a standard damaged coated substrate as described above by means of the two-component cartridge syringe. After application of the coating composition, the static mixer was disposed of and the opening of syringe was closed to allow later use of the remainder of the components in the syringe. The subsequent steps were carried out as in Example 1. After the applied coating composition was allowed to cure for about 4 hours at room temperature, the film was removed from the cured coating composition, resulting in a smoothly repaired coated substrate.

### Example 4

The same procedure as in Example 3 was followed. However, after application of the film and spreading of the surplus coating material, the panel was heated to 60° C. for 30 minutes and subsequently allowed to cool to room temperature. Immediately after cooling the film was removed from the cured coating composition, resulting in a smoothly repaired coated substrate.

### Example 5

A liquid coating composition as described in WO 01/92362 was prepared by mixing the following components:

| | |
|---|---|
| pentaerythritol tetrakis (3-mercapto propionate) | 10.0 g |
| Tolonate HDT LV | 17.9 g |
| 10 weight-% solution of Byk 306 in n-butyl acetate | 0.6 g |
| 10 weight-% solution of α-amino acetophenone | 1.1 g |
| according to formula (I) in n-butyl acetate | |

A syringe was filled with the liquid clear coat composition, and the composition was applied to the damaged area, i.e. the scratch, of a standard damaged coated substrate as described above. A small excess of coating composition was applied. Subsequently, a piece of Melinex 377 polyester film was applied on top of the applied coating composition. A slight pressure was applied to the film with a thumb in order to spread out the surplus coating material over a small area around the damaged area, resulting in a smooth transition between the original surface and the repaired area. The applied coating composition was allowed to cure for 24 hours in the dark. Then the film was removed from the cured coating composition, resulting in a smoothly repaired coated substrate. When in a parallel experiment removal of the film was carried out after only 4 hours of curing, the applied coating was damaged by cohesive failure, because the coating was insufficiently cured.

### Example 6

The same procedure as in Example 5 was followed. However, the applied coating was allowed to cure outdoors for 4 hours, i.e. it was exposed to normal daylight on a cloudy day. Subsequently, the film was removed from the cured coating composition, resulting in a smoothly repaired coated substrate.

### Example 7

The same procedure as in Example 5 was followed. However, one minute after application of the film the sample was irradiated for one minute with a UV-H 254 hand lamp from Panacol Elosol GmbH. Ten minutes after irradiation the film was removed from the cured coating composition, resulting in a smoothly repaired coated substrate.

The coating composition of Example 5 has a very long pot life and slow curing in the absence of irradiation with actinic radiation. Example 5 demonstrates that an almost invisible repair of a coated substrate is possible when such a coating composition is employed in the process according to the invention. Example 6 demonstrates that curing can be accelerated by exposure to daylight. Example 7 demonstrates that curing can be accelerated even further by exposure to UV light.

1. A process for repair of a coated substrate comprising the steps of
a) applying a liquid, ambient temperature curable two-component coating composition on an area of the coated substrate that needs to be repaired, wherein curing of the two-component coating composition commences upon mixing of the components and does not require UV or electron beam radiation or supply of thermal energy,
b) applying a film on top of the applied coating composition,
c) allowing the applied coating composition to cure, and
d) removing the film from the cured coating composition on the substrate.

2. A process according to claim 1, characterized in that the liquid, ambient temperature curable two-component coating composition is provided in a two-component cartridge.

3. A process for repair of a coated substrate comprising the steps of
a) applying at least one component of a liquid, ambient temperature curable two-component coating composition on an area of the coated substrate that needs to be repaired,
a1) applying at least one other component of the liquid, ambient temperature curable two-component coating composition to one surface of a film,
b) applying the coated surface of the film on top of the coating composition applied in step a) such that the components applied in steps a) and a1) come into contact and are at least partially mixed,
c) allowing the applied coating composition to cure, wherein curing of the applied coating commences upon mixing of the components applied in steps a) and a1) and does not require UV or electron beam radiation or supply of thermal energy, and
d) removing the film from the cured coating composition on the substrate.

4. A process according to claim 3, characterized in that in at least one of step a) and a1) a small excess of coating composition is applied, and that after the film is placed over the uncured coating composition, the small excess of coating composition on the area of the coated substrate that needs to be repaired is spread out over a small area around the area of the coated substrate that needs to be repaired by means of a pressure on the film.

5. A process according to claim 1, characterized in that the coated substrate is a metal or plastic substrate.

6. A process according to claim 1, characterized in that the coated substrate is a car or a transportation vehicle or a part thereof.

7. A process according to claim 1, characterized in that the coated substrate to be repaired is coated with a multi-layer coating.

8. A process according to claim 7, characterized in that the multi-layer coating comprises a clear top coat on a colour- or effect-imparting base coat.

9. A process according to claim 1, characterized in that the liquid, ambient temperature curable two-component coating composition comprises at least one polyisocyanate, at least one compound comprising at least one thiol group, and an α-amino acetophenone photolatent base.

10. A process according to claim 1, characterized in that the ambient temperature curable two-component coating composition is a coating composition comprising less than 40% by weight of volatile organic compounds.

11. A process according to claim 1, characterized in that allowing the applied coating composition to cure includes heating the applied coating composition to accelerate curing.

12. A process according to claim 1, characterized in that the film is actinic radiation permeable, and allowing the applied coating composition to cure includes accelerating curing by irradiation with actinic radiation through the film.

13. A process according to claim 12, characterized in that UV radiation is used as actinic radiation.

14. A process according to claim 12, characterized in that sun light is used as actinic radiation.

15. A process according to claim 12, characterized in that the curable coating composition comprises a photolatent base and a base-catalyzed polymerizable or curable material.

16. A process according to claim 1, characterized in that the film applied on top of the applied coating composition is water-soluble.

17. A process according to claim 16, characterized in that step d) is carried out by washing the film away with water or with an aqueous solution.

18. A kit of parts for carrying out a process for repair of a coated substrate, comprising
a) a film, and
b) a liquid, ambient temperature curable two-component coating composition, wherein curing of the two-component coating composition commences upon mixing of the components and does not require UV or electron beam radiation or supply of thermal energy.

19. A kit according to claim 18 further comprising
a two-component cartridge containing the liquid, ambient temperature curable two-component coating composition.

20. A process according to claim 3, characterized in that the liquid, ambient temperature curable two-component coating composition comprises at least one polyisocyanate, at least one compound comprising at least one thiol group, and an α-amino acetophenone photolatent base.

21. A process according to claim 1, characterized in that in step a) a small excess of coating composition is applied, and that after the film is placed over the uncured coating composition, the small excess of coating composition on the area of the coated substrate that needs to be repaired is spread out over a small area around the area of the coated substrate that needs to be repaired by means of a pressure on the film.
